(19) United States
(12) Patent Application Publication
(10) Pub. No.: US 2026/0249534 A1
(43) Pub. Date: Aug. 27, 2026

(54) INJECTION MOLDING MACHINE AND CONTROL METHOD THEREOF

(71) Applicant: DELTA ELECTRONICS, INC., Taoyuan City (TW)

(72) Inventors: Chia-Chun LEE, Taoyuan City (TW); Po-Lung HUANG, Taoyuan City (TW)

(21) Appl. No.: 19/260,258

(22) Filed: Jul. 3, 2025

(30) Foreign Application Priority Data
Feb. 26, 2025 (CN) 202510219045.6

(51) Int. Cl. B29C 45/82; B29C 45/50

(52) U.S. Cl. CPC B29C 45/82; B29C 2045/506; B29C 2945/7604; B29C 2945/76056; B29C 2945/76307; B29C 2945/76692; B29C 2945/76943

(57) ABSTRACT

An injection molding machine and control method thereof are provided. The machine obtains a target flow value. The machine lookup a compensation table to select a first command from multiple control commands based on the target flow value and a current oil temperature of hydraulic oil, wherein the compensation table records multiple flow values of the hydraulic oil at multiple oil temperatures. The machine controls a motor based on the first command.

### CROSS - REFERENCE TO RELATED APPLICATION

This application claims priority to China Application Serial Number 202510219045.6, filed February 26, 2025, the disclosures of which are incorporated herein by reference in their entireties.

### BACKGROUND

### Field of Invention

The present disclosure relates to a technical field related to an injection molding machine and control method thereof. More particularly, the present disclosure relates to an injection molding machine and control method thereof for adjusting a flow rate according to oil temperatures.

### Description of Related Art

When a hydraulically driven injection molding machine is under operation, a temperature change of hydraulic oil will affect the internal leakage, thereby making an output pressure unstable.

For the foregoing reasons, there is a need of a stable hydraulic control technology to solve the above problems encountered in related art approaches.

### SUMMARY

One aspect of the present disclosure provides an injection molding machine, which includes a pump, a motor, a temperature sensor, a storage and a processor. The motor is configured to drive the pump so that a hydraulic oil flows out of the pump. The temperature sensor is configured to measure a current oil temperature of the hydraulic oil. The storage is configured to store a compensation table, wherein the compensation table is configured to record a plurality of corresponding flow values of the hydraulic oil at a plurality of oil temperatures. The processor is electrically connected to the motor, the temperature sensor and the storage, wherein the processor is configured to perform following operations: obtaining a target flow value; looking up the compensation table according to the target flow value and the current oil temperature to select a first command from a plurality of control commands; and controlling the motor according to the first command.

Another aspect of the present disclosure provides a control method, which is adapt to an injection molding machine, wherein the injection molding machine includes a pump, a motor and a temperature sensor, the motor is configured to drive the pump so that a hydraulic oil flows out of the pump, the temperature sensor is configured to measure a current oil temperature of the hydraulic oil, wherein the control method comprises following steps of: obtaining a target flow value; looking up the compensation table according to the target flow value and the current oil temperature to select a first command from a plurality of control commands, wherein the compensation table is configured to record a plurality of corresponding flow values of the hydraulic oil at a plurality of oil temperatures.

It should be understood that the aforementioned general description and the following detailed description are exemplary and explanatory only and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of an injection molding machine according to a first embodiment of the present disclosure;

FIG. 2 depicts a schematic diagram of signal transmission of an injection molding machine according to some embodiments of the present disclosure;

FIG. 3 depicts a schematic diagram of an operation of editing a compensation table of an injection molding machine according to some embodiments of the present disclosure; and

FIG. 4 depicts a flow chart of a control method according to a second embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, "comprising", "including", "having", "containing", "involving" and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

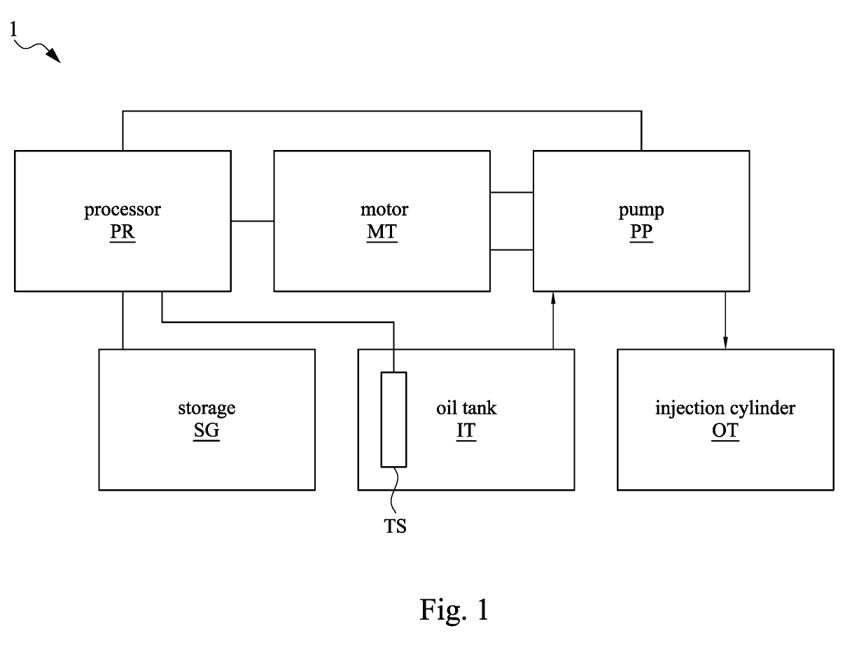

Please refer to FIG. 1, which depicts a schematic diagram of an injection molding machine 1 according to a first embodiment of the present disclosure. The injection molding machine 1 includes a processor PR, a storage SG, a motor MT, a pump PP and a temperature sensor TS, where the processor PR is electrically connected to the storage SG, the motor MT, the pump PP and the temperature sensor TS. The injection molding machine 1 is configured to control an output flow rate and/or pressure according to a temperature of a hydraulic oil.

As shown in FIG. 1, the pump PP drains the hydraulic oil from an oil tank IT and injects the hydraulic oil into an injection cylinder OT. The motor MT is configured to drive the pump PP so that the hydraulic oil flows out of the pump PP. The temperature sensor TS is disposed in the oil tank IT to measure a temperature of the hydraulic oil.

It should be noted that the temperature sensor TS can be disposed in the oil tank IT, the injection cylinder OT and/or pump PP and other components through which the hydraulic oil flows, or can be disposed around the above components which is configured to measure the oil temperature in a non-contact manner. The present disclosure is not limited thereto.

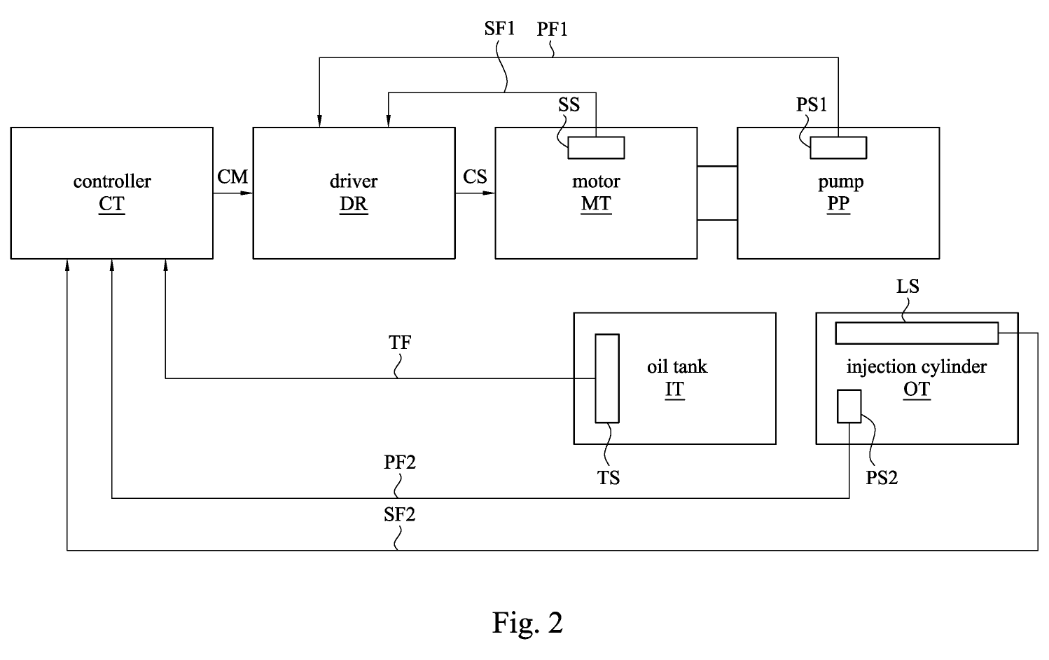

In order to facilitate the understanding actual operation of the injection molding machine 1, please refer to FIG. 2. As shown in figure, when the injection molding machine 1 is under operation, a controller CT is configured to transmit a control command CM to a driver DR to control the flow rate, the pressure and/or other parameters of the hydraulic oil output by the injection molding machine1. Correspondingly, the driver DR is configured to transmit a control signal CS to the motor MT according to the control command CM.

In addition, the motor MT is equipped with a sensor SS to measure a rotational speed of the motor MT, and the sensor SS is configured to transmit a rotational speed signal SF1 to the driver DR. Accordingly, the driver DR can be configured to estimate a flow rate of the hydraulic oil according to the rotational speed signal SF1. On the other hand, a sensor PS1 is disposed in the pump PP to measure a pressure of the hydraulic oil outputted by the pump PP, and the sensor PS1 is configured to transmit a pressure signal PF1 to the driver DR. In this way, after obtaining the rotational speed signal SF1 and the pressure signal PF1, the driver DR can be configured to adjust the control signal CS according to signals fed back by the sensors, thereby realizing closed-loop control.

On the other hand, in addition to the temperature sensor TS transmitting a measured oil temperature signal TF to the controller CT, a sensor PS2 is also disposed in the injection cylinder OT to measure the pressure of the hydraulic oil , and the sensor PS2 a pressure signal PF2 to the controller CT. In addition, a sensor LS is provide on a cylinder position gauge in the injection cylinder OT to detect an oil level of the hydraulic oil, and the sensor LS is configured to transmit a position signal SF2 to the controller CT. Accordingly, the controller CT can be configured to calculate the flow rate of the hydraulic oil according to a change of the oil level of the hydraulic oil based on the position signal SF2. In this way, after obtaining the position signal SF2 and the pressure signal PF2, the controller CT can be configured to adjust the control command CM according to signals fed back by the sensors, thereby realizing closed-loop control.

In some embodiments, the control command CM includes a pressure command and/or a flow command, which are configured to control the motor MT to drive the pump PP to output a specified pressure and/or flow rate of the hydraulic oil.

In some embodiments, the processor PR and the storage SG shown in the FIG. 1 can be disposed in the controller CT, and generate corresponding control command CM according to the position signal SF2 and the pressure signal PF2.

It should be noted that, for the sake of convenience, FIG. 2 depicts a signal transmission of the injection molding machine1. In fact, the controller CT and the driver DR can be integrated in the same component and implemented by the processor PR.

In addition, the embodiment shown in FIG. 2 is only one embodiment of the present invention. In other embodiments, the signals TF, PF1, PF2, SF1, SF2 can be transmitted to the controller CT and/or the driver DR according to actual needs to realize closed-loop control.

The storage SG is configured to store a compensation table, where the compensation table is configured to record a plurality of corresponding flow values of the hydraulic oil at a plurality of oil temperatures. Accordingly, the injection molding machine 1 is configured to control the motor MT according to the different oil temperatures of hydraulic oil by looking up the compensation table.

In some embodiments, the processor PR can include central processing units (CPU), graphics processing units (GPU), multiple processors, distributed processing systems, application specific integrated circuit (ASIC) and/or suitable computing units.

In some embodiments, storage SG can include semiconductors or solid-state memories, magnetic tapes, removable computer disks, random access memories (RAM), read-only memories (ROM), hard disks and/or optical disks.

When the injection molding machine 1 is under operation, the oil temperature of the hydraulic oil will change differently. Therefore, the injection molding machine 1 is configured to select the control command of the motor MT according to the oil temperature signal TF and the required target flow rate.

Specifically, the processor PR is configured to perform following operations: obtaining a target flow value; looking up the compensation table according to the target flow value and the current oil temperature to select a first command from a plurality of control commands; and controlling the motor according to the first command.

For example, with respect to an output of the motor MT, the controller CT can be configured to control an output intensity of the motor MT in 10 gears in the control command CM. Correspondingly, the compensation table is configured to record the actual hydraulic oil flow values of the pump PP under different oil temperatures in the 10 gears. Accordingly, after receiving the oil temperature signal TF, the controller CT can be configured to select the gear according to the target flow value and output the corresponding control command CM, so that the motor MT can drive the pump PP to output the required flow rate.

In some embodiments, the injection molding machine 1 further includes an input interface. Through the input interface, a user can input the required flow value and the pressure value. Accordingly, the injection molding machine 1 is configured to determine the target flow value and/or target pressure value according to the operation input of the user. For example, the injection molding machine 1 includes a keyboard, a mouse, a touch screen, a knob, a button and/or other interfaces.

Specifically, the injection molding machine 1 further includes an input interface (not shown in the figure), the input interface is electrically connected to the processor PR, and is configured to receive an operation input by a user; where the operation of obtaining the target flow value further includes: generating the target flow value according to the operation input.

In some embodiments, in addition to controlling an output flow of the pump PP, the injection molding machine 1 can also control the output pressure of the pump PP.

Specifically, the control commands include a plurality of pressure commands, and the operation of selecting the first command further includes: obtaining a target pressure value; and looking up the compensation table according to the target pressure value, the target flow value and the current oil temperature to select the first command from the control commands, where the first command includes one of the pressure commands.

For example, the control command CM includes a flow command and a pressure command, which are configured to instruct the driver DR to control the motor MT so that the pump PP outputs a specified flow rate and pressure respectively. Correspondingly, the compensation table also configured to store different pressure commands corresponding to the hydraulic oil pressure values outputted by the pump PP under different oil temperatures. Accordingly, the injection molding machine 1 can be configured to select a pressure command according to the current hydraulic oil temperature and the target pressure value by looking up the table, and output a corresponding control command CM, so that the motor MT can drive the pump PP to output the required flow rate.

In some embodiments, the injection molding machine 1 is configured to record the hydraulic oil flow values and/or pressure values outputted by the pump PP under different oil temperatures and different control commands CM, and is further configured to record them in the compensation table.

For example, the injection molding machine 1 is first configured to heat the hydraulic oil to a specified oil temperature by using an oil circuit pre-pressure circulation method, issue different flow commands and/or pressure commands to the motor MT, and measure corresponding flow values and/or pressure values corresponding to each command. After measuring the flow values and/or pressure value of each command at one oil temperature, the hydraulic oil is heated to another oil temperature by using the oil circuit pre-pressure circulation method, and so on, until all values under the required operating environment are measured.

Specifically, the control command CM includes a plurality of flow commands, and the processor PR is further configured to perform a plurality of first loop operations according to the oil temperatures, where each of the first loop operations includes: adjusting the current oil temperature of the hydraulic oil according to an oil temperature to be tested of the oil temperatures; controlling the motor MT according to each of the flow commands in response to the current oil temperature of the hydraulic oil meeting the oil temperature to be tested; measuring a plurality of reference flow rates of the hydraulic oil during a period when the motor MT is controlled by the flow commands; and recording the flow values and the flow commands corresponding to the flow values in the compensation table according to the reference flow rates.

Further, the operation of measuring the reference flow rates of the hydraulic oil further includes performing a plurality of second loop operations according to the flow commands, where each of the second loop operations includes: measuring a current flow rate of the hydraulic oil during a period when the motor is controlled by a flow command to be tested of the flow commands; and recording the current flow rate as one of the reference flow values in response to the current flow rate being greater than a flow threshold, where the one of the reference flow values corresponds to the flow command to be tested and the current oil temperature of the hydraulic oil.

Specifically, the control command CM includes plurality of pressure commands, and the processor PR is further configured to perform a plurality of third loop operations according to the oil temperatures, where each of the third loop operations includes: adjusting the current oil temperature of the hydraulic oil according to an oil temperature to be tested of the oil temperatures; controlling the motor MT according to each of the pressure commands in response to the current oil temperature of the hydraulic oil meeting the oil temperature to be tested; measuring a plurality of reference pressure values of the hydraulic oil during a period when the MT is controlled by the pressure commands; and recording a plurality of pressure values and the pressure commands corresponding to the pressure values in the compensation table according to the reference pressure values.

Further, the operation of measuring reference pressure values of the hydraulic oil further includes performing a plurality of fourth loop operations according to the pressure commands, where each of the fourth loop operations includes: measuring a plurality of current pressure values of the hydraulic oil during a period when the motor is controlled by a pressure command to be tested of the pressure commands; and generating one of the reference pressure values according to the current pressure values in response to a change value of the current pressure values being less than a second threshold, where the one of the reference pressure values corresponds to the pressure command to be tested and the current oil temperature of the hydraulic oil.

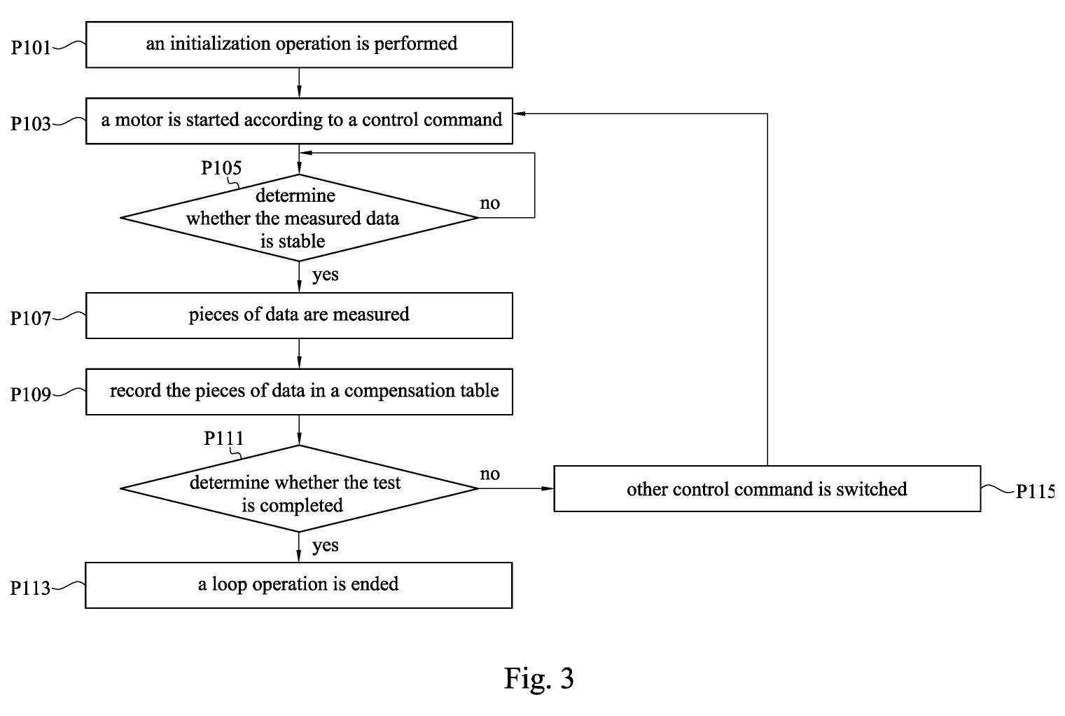

Regarding the operation of editing the compensation table by the injection molding machine 1, please refer to FIG. 3. It should be noted that the operation flow depicted in FIG. 3 can be configured to edit the flow command and the pressure command in the compensation table. Following paragraph of the present disclosure will first explain the operation of the edit flow command.

First, in the operation P101, the injection molding machine 1 is configured to perform an initialization operation.

In some embodiments, the initialization operation includes preparations before testing flow values. For example, before testing the flow values, the injection molding machine 1 is configured to loosen a screw of the injection cylinder OT to a maximum position (i.e., move the injection axis screw to the end terminal) to ensure that the injection cylinder OT has enough space to accommodate the hydraulic oil.

In some embodiments, in order to measure an oil volume value at a specified oil temperature, the initialization operation further includes heating the hydraulic oil to a specified temperature by using an oil circuit pre-pressure circulation method.

Next, in the operation P103, the injection molding machine 1 is configured to start the motor MT according to the control command CM. Specifically, the injection molding machine 1 is configured to generate the control command CM according to the flow command required for the test, and start the motor MT according to the control command CM.

In some embodiments, in order to maintain a stable test environment, the injection molding machine 1 is configured to generate control command CM with a specified pressure command. For example, when testing the flow value, the controller CT is configured to output the same pressure command to the driver DR to maintain the same test environment.

Next, in the operation P105, the injection molding machine 1 is configured to determine whether the measured flow data (e.g.: the rotational speed signal SF1 and/or the position signal SF2) is stable.

Since the flow rate of the hydraulic oil can be not stable when the motor MT is just started, the injection molding machines1 is configured to determine whether the flow data is stable or not at first, and then record the flow value. For example, the processor PR is configured to calculate a moving speed of the oil level of the hydraulic oil according to a plurality of position signals SF2 measured by the sensor LS. Further, the injection molding machine 1 is configured to determine whether the displacement of the oil level of the hydraulic oil exceeds a specified threshold value (e.g.:100 mm). If the displacement exceeds the threshold, it means that the flow data has stabilized, and the operation P107 can be entered to start measuring the flow value. On the contrary, if the displacement does not exceed the threshold, the value will continue to be determined in the operation P105.

Next, in the operation P107, the injection molding machine 1 is configured to measure the flow value of the hydraulic oil. Similar to the aforementioned embodiment, the injection molding machine 1 can be configured to calculate a flow rate of the hydraulic oil according to the rotational speed signal SF1 transmitted by the sensor SS and/or the position signal SF2 transmitted by the sensor LS. However, in actual applications, the injection molding machine 1 may be measured in other ways, and the present disclosure is not limited thereto.

After measuring the flow data, in the operation P109, the injection molding machine 1 is configured to record the flow values in the compensation table, where the compensation table is further configured to record the hydraulic oil temperatures and the flow commands corresponding to the flow values.

Next, in the operation P111, the injection molding machine 1 is configured to determine whether the test is completed. If there are other flow commands that have not tested, the injection molding machine 1 is configured to enter the operation P115 to switch to other flow commands, and perform the test again. On the contrary, if all required flow commands are completed, the operation P113 is entered to end the loop operation and complete the test.

It should be noted that if a plurality of different oil temperatures need to be tested, the injection molding machine 1 can be configured to execute the loop operation shown in FIG. 3 according to the other oil temperatures. In some embodiments, the injection molding machine 1 is configured to perform the loop operation shown in FIG. 3 multiple times for each oil temperatures to be tested, where a number of times executed is an integer multiple of a number of the oil temperatures.

Specifically, a number of times which the processor executes the first loop operations is an integer multiple of a number of the oil temperatures, and each of the first loop operations is as the oil temperature to be tested according to the each of the oil temperatures.

As for the operation of editing the pressure command in the compensation table, the present disclosure also uses FIG. 3 as an example for explanation.

First, in the operation P101, the injection molding machine 1 is configured to perform an initialization operation.

In some embodiments, the initialization operation includes preparations before testing the pressure values. For example, before testing the pressure, the injection molding machine 1 is configured to move a screw of the injection cylinder OT to a minimum position (i.e., move the injection axis screw to the front terminal) to ensure that the injection cylinder OT can generate actual pressure values.

In some embodiments, in order to measure an oil volume value at a specified oil temperature, the initialization operation further includes heating the hydraulic oil to a specified temperature by using an oil circuit pre-pressure circulation method.

Next, in the operation P103, the injection molding machine1 is configured to start the motor MT according to the control command CM. Specifically, the injection molding machine 1 s configured to generate the control command CM according to the pressure command required for the test, and start the motor MT according to the control command CM.

In some embodiments, in order to maintain a stable test environment, the injection molding machine 1 is configured to generate control command CM with a specified flow command. For example: when testing pressure value, the controller CT is configured to output the same flow command to the driver DR to maintain the same test environment.

Next, in the operation P105, the injection molding machine 1 is configured to determine whether the measured pressure data (e.g.: the pressure signal PF1 and/or the pressure signal PF2) is stable.

Since the pressure of the hydraulic oil can be not stable when the motor MT is just started, the injection molding machine 1 is configured to determine whether the pressure data is stable or not at first, and then record the pressure value. For example, the processor PR is configured to calculate a variation of pressure values of the hydraulic oil within a period of time according to the pressure signals PF1 measured by the sensor PS1 and/or the pressure signals PF2 measured by the sensor PS2. Further, the injection molding machine 1 is configured to determine whether the variation of pressure exceeds a specified threshold value (e.g.:2 bar). If the variation of pressure values is less than the threshold, it means that the pressure data has stabilized and, and the operation P107 can be entered to start measuring the pressure value. On the contrary, if the variation of pressure values exceeds the threshold, the value will continue to be determined in the operation P105.

Next, in the operation P107, the injection molding machine 1 is configured to measure the pressure value of the hydraulic oil. Similar to the aforementioned embodiment, the injection molding machine 1 can be configured to calculate a pressure of the hydraulic oil according to the rotational speed signal SF1 transmitted by the sensor PS1 and/or the pressure signal PF2 transmitted by the sensor PS2. However, in in actual applications, the injection molding machine 1 may also be measured in other ways, and the present disclosure is not limited thereto.

After measuring the pressure data, in the operation P109, the injection molding machine 1 is configured to record the pressure value in the compensation table, where the compensation table is further configured to record the hydraulic oil temperatures and the pressure commands corresponding to the pressure values.

Next, in the operation P111, the injection molding machine 1 is configured to determine whether the test is completed. If there are other pressure commands that have not tested, the injection molding machine 1 is configured to enter the operation P115 to switch to other pressure commands, and perform the test again. On the contrary, if all required flow commands are completed, the operation P113 is entered to end the loop operation and complete the test.

It should be noted that if a plurality of different oil temperatures need to be tested, the injection molding machine 1 can be configured to execute the loop operation shown in FIG. 3 according to the other oil temperatures. In some embodiments, the injection molding machine 1 is configured to perform the loop operation shown in FIG. 3 multiple times for each oil temperature to be tested, where a number of times executed is an integer multiple of a number of the oil temperatures.

Specifically, a number of times which the processor PR executes the third loop operations is an integer multiple of a number of the oil temperatures, and each of the third loop operations is as the oil temperature to be tested according to the oil temperatures.

In some embodiments, the injection molding machine 1 can be further configured to establish a linear model according to a plurality of flow values and/or pressure values, where the linear model is configured to record a relationship between the oil temperatures and flow values and/or a relationship between the oil temperatures and the pressure values. Accordingly, the injection molding machine 1 can be configured to estimate flow values and/or pressure values at the other oil temperatures according to flow values and/or pressure values at a limited number of the oil temperatures so as to control the motor MT accurately.

Specifically, the processor PR is further configured to perform following operations: calculating a linear model according to the oil temperatures and corresponding flow values in the compensation table, where the linear model is configured to represent a linear relationship between the flow values and the oil temperatures of the hydraulic oil.

Specifically, the processor PR is further configured to perform following operations: calculating a linear model according to the oil temperatures and corresponding pressure values in the compensation table, where the linear model is configured to represent a linear relationship between the pressure values and the oil temperatures of the hydraulic oil.

In summary, the injection molding machine 1 is provided by the present disclosure can more accurately control the output of the motor MT and the pump PP according to the compensation table, thereby reducing the impact caused by changes in oil temperatures. In addition, through multiple measurements, the injection molding machine 1 can be configured to establish a compensation table and a linear model to achieve a more accurate control method.

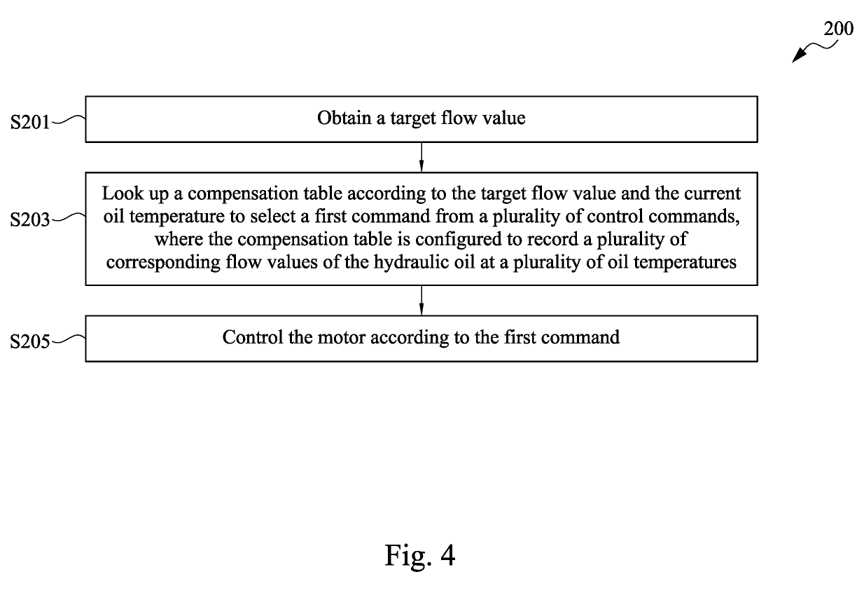

Please refer to FIG. 4, which is a flow chart of the control method 200 in a second embodiment of the present disclosure. The control method 200 includes steps S201, S203 and S205. The control method 200 can be executed by an injection molding machine (e.g.: injection molding machine 1 in the first embodiment). The control method 200 is configured to the output flow and/or pressure of the injection molding machine according to the temperatures of the hydraulic oil.

First, in step S201, the injection molding machine is configured to obtain a target flow value.

Then, in step S203, the injection molding machine is configured to look up a compensation table according to the target flow value and the current oil temperature to select a first command from a plurality of control commands, where the compensation table is configured to record a plurality of corresponding flow values of the hydraulic oil at a plurality of oil temperatures.

Finally, in step S205, the injection molding machine is configured to control the motor according to the first command.

In some embodiments, the control commands includes a plurality of flow commands, and the control method 200 further includes the injection molding machine performing a plurality of first loop operations according to the oil temperatures, where each of the first loop operations include the injection molding machine adjusting the current oil temperature of the hydraulic oil according to an oil temperature to be tested of the oil temperatures; the injection molding machine controlling the motor according to each of the flow commands in response to the current oil temperature of the hydraulic oil meeting the oil temperature to be teste; the injection molding machine measuring a plurality of reference flow rates of the hydraulic oil during a period when the motor is controlled by the flow commands; and the injection molding machine recording the flow values and the flow commands corresponding to the flow values in the compensation table according to the reference flow rates.

In some embodiments, the step of measuring the reference flow rates of the hydraulic oil further includes the injection molding machine performing a plurality of second loop operations according to the flow commands, where each of the second loop operations includes the injection molding machine measuring a current flow rate of the hydraulic oil during a period when the motor is controlled by a flow command to be tested of the flow commands; and the injection molding machine recording the current flow rate as one of the reference flow values in response to the current flow rate being greater than a flow threshold, where the one of the reference flow values corresponds to the flow command to be tested and the current oil temperature of the hydraulic oil.

In some embodiments, the control method 200 executes the first loop operations a number of times which is an integer multiple of a number of the oil temperatures, and each of the first loop operations is as the oil temperature to be tested according to the each of the oil temperatures.

In some embodiments, the control commands include a plurality of pressure commands, and the step S203 further includes the injection molding machine obtaining a target pressure value; and the injection molding machine looking up the compensation table according to the target pressure value, the target flow value and the current oil temperature to select the first command from the control commands, where the first command comprise one of the pressure commands.

In some embodiments, the control method 200 further includes the injection molding machine performing a plurality of third loop operations according to the oil temperatures, where each of the third loop operations includes the injection molding machine adjusting the current oil temperature of the hydraulic oil according to an oil temperature to be tested of the oil temperatures; the injection molding machine controlling the motor according to each of the pressure commands in response to the current oil temperature of the hydraulic oil meeting the oil temperature to be tested; the injection molding machine measuring a plurality of reference pressure values of the hydraulic oil during a period when the motor is controlled by the pressure commands; and the injection molding machine recording a plurality of pressure values and the pressure commands corresponding to the pressure values in the compensation table according to the reference pressure values.

In some embodiments, the step of measuring reference pressure values of the hydraulic oil further includes the injection molding machine performing a plurality of fourth loop operations according to the pressure commands, where each of the fourth loop operations includes the injection molding machine measuring a plurality of current pressure values of the hydraulic oil during a period when the motor is controlled by a pressure command to be tested of the pressure commands; and the injection molding machine generating one of the reference pressure values according to the current pressure values in response to a change value of the current pressure values being less than a second threshold, where the one of the reference pressure values corresponds to the pressure command to be tested and the current oil temperature of the hydraulic oil.

In some embodiments, the control method 200 executes the third loop operations a number of times which is an integer multiple of a number of the oil temperatures, and each of the third loop operations is as the oil temperature to be tested according to the each of the oil temperatures.

In some embodiments, the control method 200 further includes the injection molding machine calculating a linear model according to the oil temperatures and corresponding flow values in the compensation table, wherein the linear model is configured to represent a linear relationship between the flow values and the oil temperatures of the hydraulic oil.

In some embodiments, the control method 200 further includes the injection molding machine calculating a linear model according to the oil temperatures and corresponding pressure values in the compensation table, wherein the linear model is configured to represent a linear relationship between the pressure values and the oil temperatures of the hydraulic oil.

In some embodiments, the injection molding machine further includes an input interface, the input interface is configured receive an operation input by a user, and the step S201 further includes the injection molding machine generating the target flow value according to the operation input.

In summary, the control method 200 proposed in the present disclosure can more accurately control the output of the motor and the pump based on the compensation table, thereby reducing the impact caused by changes in oil temperature. In addition, through multiple measurements, the control method 200 can establish a compensation table and a linear model to achieve a more accurate control method.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An injection molding machine, comprising:
a pump;
a motor, configured to drive the pump so that a hydraulic oil flows out of the pump;
a temperature sensor, configured to measure a current oil temperature of the hydraulic oil;
a storage, configured to store a compensation table, wherein the compensation table is configured to record a plurality of corresponding flow values of the hydraulic oil at a plurality of oil temperatures; and
a processor, electrically connected to the motor, the temperature sensor and the storage, wherein the processor is configured to perform following operations:
obtaining a target flow value;
looking up the compensation table according to the target flow value and the current oil temperature to select a first command from a plurality of control commands; and
controlling the motor according to the first command.

2. The injection molding machine of claim 1, wherein the control commands comprise a plurality of flow commands, and the processor is further configured to perform a plurality of first loop operations according to the oil temperatures, wherein each of the first loop operations comprises:
adjusting the current oil temperature of the hydraulic oil according to an oil temperature to be tested of the oil temperatures;
controlling the motor according to each of the flow commands in response to the current oil temperature of the hydraulic oil meeting the oil temperature to be tested;
measuring a plurality of reference flow rates of the hydraulic oil during a period when the motor is controlled by the flow commands; and
recording the flow values and the flow commands corresponding to the flow values in the compensation table according to the reference flow rates.

3. The injection molding machine of claim 2, wherein the operation of measuring the reference flow rates of the hydraulic oil further comprises performing a plurality of second loop operations according to the flow commands, wherein each of the second loop operations comprises:
measuring a current flow rate of the hydraulic oil during a period when the motor is controlled by a flow command to be tested of the flow commands; and
recording the current flow rate as one of the reference flow values in response to the current flow rate being greater than a flow threshold, wherein the one of the reference flow values corresponds to the flow command to be tested and the current oil temperature of the hydraulic oil.

4. The injection molding machine of claim 2, wherein a number of times which the processor executes the first loop operations is an integer multiple of a number of the oil temperatures, and each of the first loop operations is as the oil temperature to be tested according to the each of the oil temperatures.

5. The injection molding machine of claim 1, wherein the control commands comprise a plurality of pressure commands, and the operation of selecting the first command further comprises:
obtaining a target pressure value; and
looking up the compensation table according to the target pressure value, the target flow value and the current oil temperature to select the first command from the control commands, wherein the first command comprises one of the pressure commands.

6. The injection molding machine of claim 5, wherein the processor is further configured to perform a plurality of third loop operations according to the oil temperatures, wherein each of the third loop operations comprises:
adjusting the current oil temperature of the hydraulic oil according to an oil temperature to be tested of the oil temperatures;
controlling the motor according to each of the pressure commands in response to the current oil temperature of the hydraulic oil meeting the oil temperature to be tested;
measuring a plurality of reference pressure values of the hydraulic oil during a period when the motor is controlled by the pressure commands; and
recording a plurality of pressure values and the pressure commands corresponding to the pressure values in the compensation table according to the reference pressure values.

7. The injection molding machine of claim 6, wherein the operation of measuring reference pressure values of the hydraulic oil further comprises performing a plurality of fourth loop operations according to the pressure commands, wherein each of the fourth loop operations comprises:
measuring a plurality of current pressure values of the hydraulic oil during a period when the motor is controlled by a pressure command to be tested of the pressure commands; and
generating one of the reference pressure values according to the current pressure values in response to a change value of the current pressure values being less than a second threshold, wherein the one of the reference pressure values corresponds to the pressure command to be tested and the current oil temperature of the hydraulic oil.

8. The injection molding machine of claim 6, wherein a number of times which the processor executes the third loop operations is an integer multiple of a number of the oil temperatures, and each of the third loop operations is as the oil temperature to be tested according to the oil temperatures.

9. The injection molding machine of claim 1, wherein the processor is further configured to perform following operations:
calculating a linear model according to the oil temperatures and corresponding flow values in the compensation table, wherein the linear model is configured to represent a linear relationship between the flow values and the oil temperatures of the hydraulic oil.

10. The injection molding machine of claim 1, further comprising:
an input interface, electrically connected to the processor, wherein the input interface is configured receive an operation input by a user;
wherein the operation of obtaining the target flow value further comprises:
generating the target flow value according to the operation input.

11. A control method, adapt to an injection molding machine, wherein the injection molding machine comprises a pump, a motor and a temperature sensor, the motor is configured to drive the pump so that a hydraulic oil flows out of the pump, the temperature sensor is configured to measure a current oil temperature of the hydraulic oil, and wherein the control method comprises following steps of:
obtaining a target flow value;
looking up a compensation table according to the target flow value and the current oil temperature to select a first command from a plurality of control commands, wherein the compensation table is configured to record a plurality of corresponding flow values of the hydraulic oil at a plurality of oil temperatures; and
controlling the motor according to the first command.

12. The control method of claim 11, wherein the control commands comprise a plurality of flow commands, wherein the control method further comprise performing a plurality of first loop operations according to the oil temperatures, wherein each of the first loop operations comprises:
adjusting the current oil temperature of the hydraulic oil according to an oil temperature to be tested of the oil temperatures;
controlling the motor according to each of the flow commands in response to the current oil temperature of the hydraulic oil meeting the oil temperature to be tested;
measuring a plurality of reference flow rates of the hydraulic oil during a period when the motor is controlled by the flow commands; and
recording the flow values and the flow commands corresponding to the flow values in the compensation table according to the reference flow rates.

13. The control method of claim 12, wherein the step of measuring the reference flow rates of the hydraulic oil further comprises performing a plurality of second loop operations according to the flow commands, wherein each of the second loop operations comprises:
measuring a current flow rate of the hydraulic oil during a period when the motor is controlled by a flow command to be tested of the flow commands; and
recording the current flow rate as one of the reference flow values in response to the current flow rate being greater than a flow threshold, wherein the one of the reference flow values corresponds to the flow command to be tested and the current oil temperature of the hydraulic oil.

14. The control method of claim 12, wherein the control method executes the first loop operations a number of times which is an integer multiple of a number of the oil temperatures, and each of the first loop operations is as the oil temperature to be tested according to the each of the oil temperatures.

15. The control method of claim 11, wherein the control commands comprise a plurality of pressure commands, and the step of selecting the first command further comprises:
obtaining a target pressure value; and
looking up the compensation table according to the target pressure value, the target flow value and the current oil temperature to select the first command from the control commands, wherein the first command comprise one of the pressure commands.

16. The control method of claim 15, wherein the control method further comprises performing a plurality of third loop operations according to the oil temperatures, wherein each of the third loop operations comprises:
adjusting the current oil temperature of the hydraulic oil according to an oil temperature to be tested of the oil temperatures;
controlling the motor according to each of the pressure commands in response to the current oil temperature of the hydraulic oil meeting the oil temperature to be tested;
measuring a plurality of reference pressure values of the hydraulic oil during a period when the motor is controlled by the pressure commands; and
recording a plurality of pressure values and the pressure commands corresponding to the pressure values in the compensation table according to the reference pressure values.

17. The control method of claim 16, wherein the step of measuring reference pressure values of the hydraulic oil further comprises performing a plurality of fourth loop operations according to the pressure commands, wherein each of the fourth loop operations comprises:
measuring a plurality of current pressure values of the hydraulic oil during a period when the motor is controlled by a pressure command to be tested of the pressure commands; and
generating one of the reference pressure values according to the current pressure values in response to a change value of the current pressure values being less than a second threshold, wherein the one of the reference pressure values corresponds to the pressure command to be tested and the current oil temperature of the hydraulic oil.

18. The control method of claim 16, wherein the control method executes the third loop operations a number of times which is an integer multiple of a number of the oil temperatures, and each of the third loop operations is as the oil temperature to be tested according to the each of the oil temperatures.

19. The control method of claim 11, further comprising:
calculating a linear model according to the oil temperatures and corresponding flow values in the compensation table, wherein the linear model is configured to represent a linear relationship between the flow values and the oil temperatures of the hydraulic oil.

20. The control method of claim 11, wherein the injection molding machine further comprises an input interface, the input interface is configured receive an operation input by a user, wherein the step of obtaining the target flow value further comprises:
generating the target flow value according to the operation input.
